(19) United States
(12) Patent Application Publication
(10) Pub. No.: US 2011/0033066 A1
(43) Pub. Date: Feb. 10, 2011

(54) Circular speaker

(76) Inventor: James Siegrist, Cathedral City, CA (US)

Correspondence Address: Allan Grant, 17351 Greentree Dr., Riverside, CA, 92503, US

(21) Appl. No.: 12/462,566

(22) Filed: Aug. 4, 2009

(51) Int. Cl. H04R 1/02; G10H 1/00

(52) U.S. Cl. 381/118; 381/152

(57) ABSTRACT

A device comprising a circular shaped resonating chamber having an upper resonating chamber and a lower resonating chamber, which are joined together by a sound board, the sound board divides said upper resonating chamber and said lower resonating chamber, wherein one or more speakers are mounted to the sound board, the sound board has one or more breather holes, the upper resonating chamber has one or more exit holes for the sound to escape, and a base member for holding the circular shaped resonating chamber, the base member is a guitar amplifier, and the resonating chamber allows the sound waves to travel from the speaker to resonate sound into the sound board and out through the circular shaped structured walls outward in a 360 degree radius.

### CROSS-REFERENCE TO RELATED APPLICATIONS

The present application claims priority under 35 U.S.C. 120 and under all applicable U.S. statutes and regulations, to U.S. application Ser. No. 29/314,045 filed on Feb. 27, 2009. The disclosure of which is hereby incorporated herein by reference in its entirety.

### FIELD OF THE INVENTION

The present invention relates in general to speaker devices and more particularly to an improved speaker for musical instrument amplifier device having an unique design and structure for providing improved sound qualities.

### BACKGROUND

A guitar amplifier (or guitar amp) is an electric amplifier designed to make the signal of an electric or acoustic guitar louder so that it will produce sound through a loudspeaker and modify the tone by emphasizing or de-emphasizing certain frequencies and adding electronic effects.

Since 1947 the invention of the guitar amplifier enclosure has been of a box shape, usually made of wood. Over the years there have been great advances in electronics, unfortunately they considered the box design enclosure as a simply container to mount the electronics and not as a source of new technology advancement. As such, this invention seeks to change that by creating a novel and new design of a Circular Speaker Enclosure, which not only creates a unique look but helps shape and deliver sound a novel sound. By mounting the speaker components deep inside a circular enclosure and trapping air to use as a spring board, to achieve a crisper cleaner sound that is delivered.

The principal physics that this invention was based on is the Helmholtz Resonance. The name comes from a device created in the 1850s by Herman von Helmholz to show the height of the various tones. An example of Helmholtz resonance is the sound created when one blows across the top of an empty bottle. When air is forced into a cavity, the pressure inside increases. Once the external force that forces the air into the cavity disappears, the higher-pressure air inside will flow out. However, this surge of air flowing out will tend to over-compensate, due to the inertia of the air in the neck, and the cavity will be left at a pressure slightly lower than the outside, causing air to be drawn back in. This process repeats with the magnitude of the pressure changes decreasing each time. This effect is akin to that of a bungee-jumper bouncing. The principal physics in the end of a bungee rope, or a mass attached to a spring. Air trapped in the chamber acts as a spring. Changes in the dimensions of the chamber adjust the properties of the spring effect, a larger chamber would make for a weaker spring effect and vice-versa. The air in the port(neck of the chamber) is the mass. Since it is in motion, it possesses some momentum. A longer port would make for a larger mass, and vice versa. The diameter of the port is related to the mass of air and the volume of the chamber. A port that is too small in area for the chamber volume will “choke” the flow while one that is too large in area for the chamber volume tends to reduce the momentum of the air in the port.

A standard guitar amp only resonate sound in a forward direction and is square in shape and is open backed. As a result, sound wave are only traveling in one direction. Whereas this invention uses a circular shape enclosure having no right angles and only one opening, which is angled straight up to allow the sound waves to travel and resonate in a 360 degree radius. Additionally, with this invention, the one enclosure is used to trapped the air inside as a spring to help oscillate the sound as the internal pressure expands and compresses. Thereby deliver a crisper cleaner sound. Additionally, if used as a musical instrument amplifier it can be adjusted by pointing the opening straight upward to radiate sound in a 360 degree radius pattern and/or is fully adjustable from vertical to a 45 degrees angle to projecting the sound forward, if desired. The result of this invention is a great improvement in speaker amplification for Hi Fi listening and musical instrument amplification.

### SUMMARY OF THE INVENTION

The present invention specifically addresses and alleviates the above deficiencies associated with the prior art. In this regard, the present invention provides a substantial need in the art for a new musical instrument amplifier.

It is an object of this invention to provide an improved speaker.

It is an object of this invention to provide an improved guitar amplifier.

It is an object of this invention to provide a circular shaped speaker having an upper resonating chamber 20, a lower resonating chamber 30, a sound board 40, a speaker 50, breather holes 60, interior resonating chamber wall 70 and an exit sound hole 80.

It is an object of this invention to provide increased volume especially in the lower tones.

It is also an object of this invention to provide higher end sounds by mounting the tweeter speakers above the woofers, to balanced the sound system for high volume and crystal clear sound.

It is an object of this invention to position the main speaker in the middle of the sound board to help resonate the sound throughout through the circular enclosure walls.

It is an object of this invention to provide factors for adjusting the sound: (1) the exit sound hole size, effects the overall tone; (2) the center sound boards thickness and density, effects the overall tone; (3) the breather hole size and shape on the sound board, effects the tone and response; (4) this device should be completely sealed except for the exit sound hole and unlike a standard speaker, covering the exit sound hole with fabric or material will block the free flow of air oscillation and hinder performance.

It is an object of this invention to provide lower end woofers, one or more work best mounted to the center sound board. One or more midrange speakers can be mounted to the central sounding board or mounted above the sounding board.

It is an object of this invention to provide higher end tweeter or tweeters by mounting it above the lower end speakers closer to the exit sounding hole.

The circular shaped enclosure can also be mounted inside an electrically amplified musical instrument such as a guitar, piano, or PA system or hand held device.

It is an object of this invention to allow the circular shaped enclosure to be made of any material that will trap air to create the oscillating effects. The construction works well made from wood, plastic, or metals.

It is an object of this invention to provide a circular shaped speaker enclosure that will resonate sound in a 360 degree radius, when the exit sound hole is pointed straight up vertically to allow the sound waves to travel and resonate in a 360 degree radius.

It is an object of this invention to provide a speaker enclosure that will allow the user to adjust the angle and direction of the sound by tilting the exit hole as desired. For example, a musical instrument amplifier can be adjusted by pointing the opening straight upward to radiate sound in a 360 degree radius pattern; or adjusted from a vertical angle to a 45 degrees angle or even a 90 degree angle which would angle the speaker enclosure and alter the direction of the sound.

It is an object of this invention to provide a speaker with one enclosure which is used to trapped the air inside as a spring to help oscillate the sound as the internal pressure expands and compresses. Thereby deliver a crisper cleaner sound.

It is an object of this invention that it can be used to replace any sound speaker enclosure.

It is an object of this invention to provide certain manufacturing advantages by utilizing a circular shape enclosure. In that not only the weight and strength but the cost to vacuum form or spin/heat stamp the enclosure as it is far more economical and less labor intensive to produce.

It is also an object of the present invention to provide a musical instrument amplifier that is easy to manufacture, simple to assemble, reliable in operation, and relatively inexpensive to produce.

### BRIEF DESCRIPTION OF THE FIGURES

These as well as other features of the present invention will become more apparent upon reference to the accompanying drawings wherein like numerals designate corresponding parts in the several figures summarized as follows:

FIG. 1 is a perspective view of the circular shaped speaker connected to a musical instrument amplifier.

FIG. 1(A) is an exploded view of the circular shaped speaker for use with the musical instrument amplifier.

FIG. 2 is a front view of the circular shaped musical instrument amplifier.

FIG. 3 is a back view of the circular shaped musical instrument amplifier.

FIG. 4 is a side view of the circular shaped musical instrument amplifier.

FIG. 5 is the other side view of the circular shaped musical instrument amplifier.

FIG. 6 is an overhead view of the circular shaped musical instrument amplifier, when it is positioned at a 90 degree angle.

FIG. 7 is an overhead view of the circular shaped musical instrument amplifier, when it is positioned at a 90 degree angle.

Other features and advantages of the invention will be become apparent from the following detailed description, taken in conjunction with the accompany drawings, which illustrate, by way of example, various features of the invention.

### DETAILED DESCRIPTION

The following detailed description and accompanying drawings are provided for purposes of illustrating and describing presently preferred embodiments of the present invention and are not intended to limit the scope of the invention in anyway. It will be understood that various changes in the details, materials, arrangements of parts or operational conditions which have been herein described and illustrated in order to explain the nature of the invention may be made by those skilled in the art within the principles and the scope of the invention.

A Helmholtz resonator or Helmholtz oscillator is a container of gas (usually air) with an open hole (or neck or port). A volume of air in and near the open hole vibrates because of the springiness of the air inside. A common example is a empty bottle: the air inside vibrates when you blow across the top. In fact, it is quite surprising to hear the low and loud sounds that result.

The vibration here is due to the springiness of air: when you compress it, its pressure increases and tends to expand back to its original volume. Consider a lump of air at the neck of the bottle. The air jet can force this lump of air out but, when it gets to its original position, its momentum takes it on outside the body a small distance. This rarifies the air inside the body, which then sucks the lump of air back in. It can thus vibrate like a mass on a spring. The jet of air from your lips is capable of deflecting alternately into the bottle and outside, and that provides the power to keep the oscillation going.

Used as a guitar amplifier 5, it becomes clear by holding your hand over the top of the enclosure exit hole, when in use, there is a tremendous air movement over the top of the enclosure and increased volume especially in the lower tones.

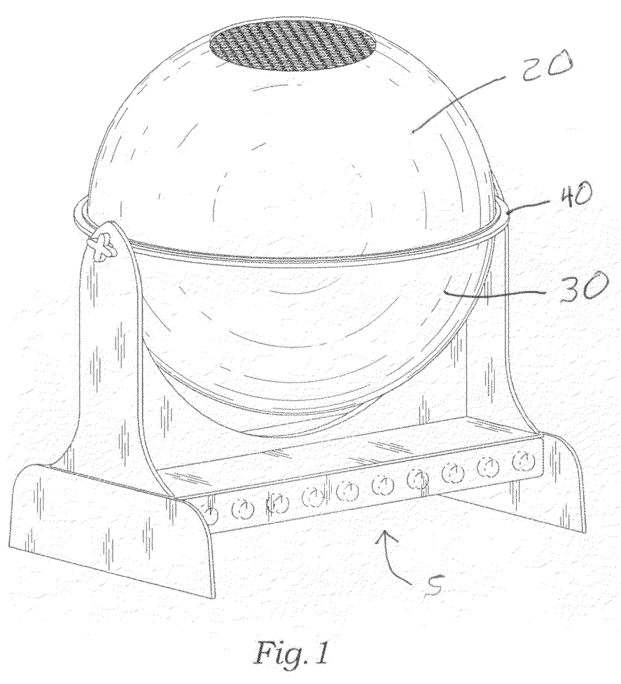

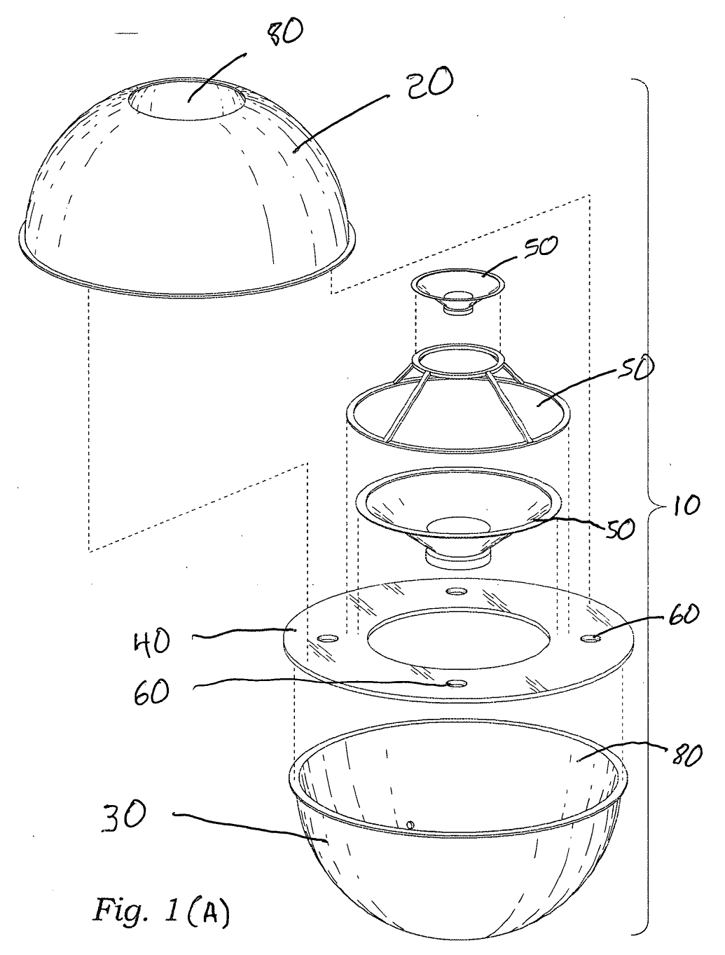

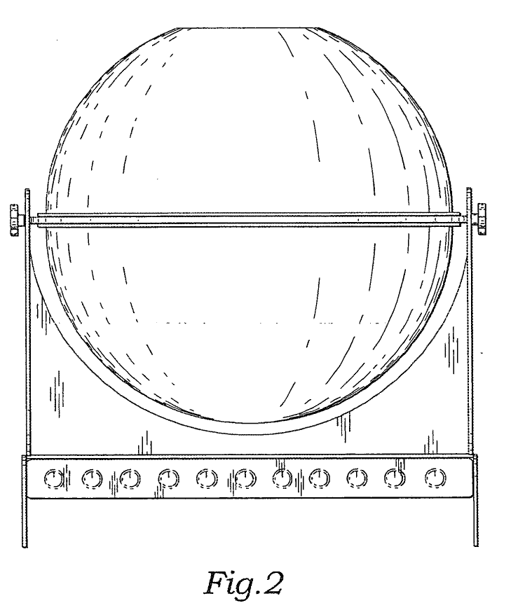

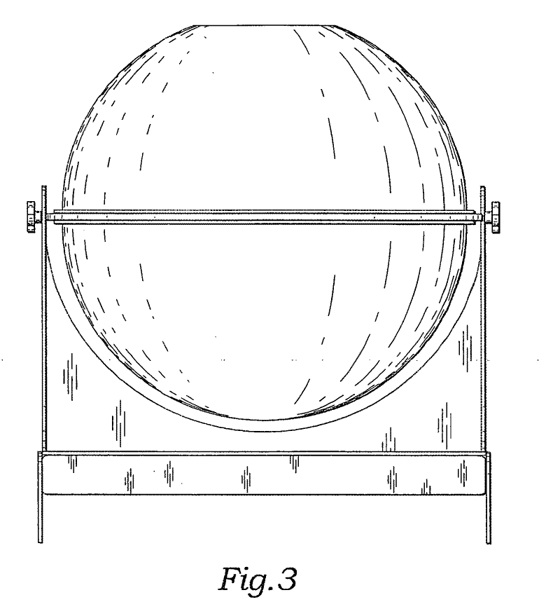

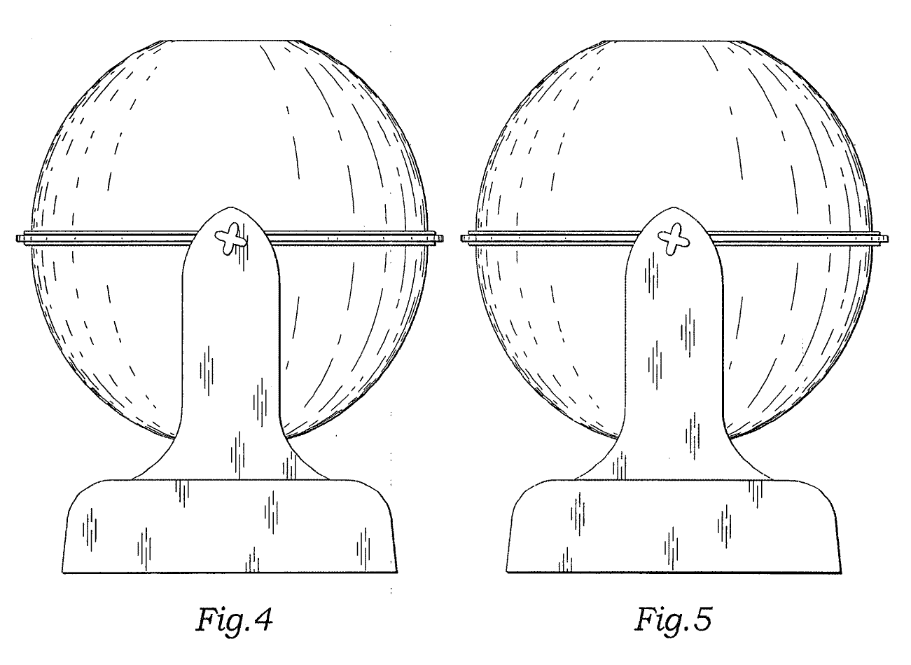

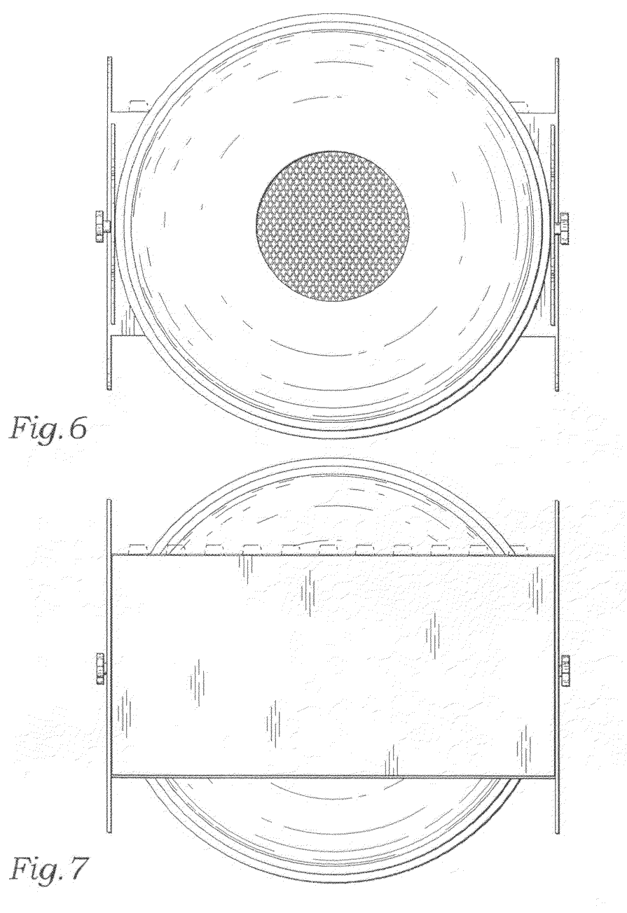

Referring to the drawings more particularly by reference numbers, FIGS. 1 through 7 show a preferred embodiment of the invention, a circular shaped speaker 10 comprised of an upper resonating chamber 20 and a lower resonating chamber 30. Both the upper resonating chamber 20 and lower resonating chamber 30 are divide by a sound board 40, wherein a speaker or speakers 50 are mounted in the central area of the sound board 40. The upper and lower resonating chambers (20 & 30) are joined together with the sound board 40.

When an electrical signal is sent to the speaker causing it to expand and contrast raising and lowering the pressure and in the upper and lower resonating (20 & 30).

The lower resonating chamber 30 draws air in or out through the breather hole or holes 60 located in the sound board 40.

Air pressure moves through the breather hole or holes 60 from the lower resonating chamber 30 into the upper resonating chamber 20 along the interior resonating chamber wall 70 to exit through the upper resonating chamber's sound hole or holes 80.

This circular design allows the sound waves from the speaker 50 to resonate sound into sound board 40 out through the circular shaped structured walls outward in a 360 degree radius.

In the preferred embodiment of the invention, a circular shaped speaker is comprised of an upper resonating chamber 20, a lower resonating chamber 30, a sound board 40, a speaker 50, breather holes 60, interior resonating chamber wall 70 and an exit sound hole 80.

In an alternative embodiment, a higher end tweeter speaker can be mounted above the woofers to balanced the sound system for high volume and crystal clear sound.

In an alternative embodiment, a user could mounting the main speaker in the middle of the sound board helps resonate the sound out through the enclosure walls.

The following key factor are useful in adjusting the sound: (1) the exit sound hole size, effects the overall tone; (2) the center sound boards thickness and density, effects the overall tone; (3) the breather hole size and shape on the sound board, effects the tone and response; (4) this device should be completely sealed except for the exit sound hole and unlike a standard speaker, covering the exit sound hole with fabric or material will block the free flow of air oscillation and hinder performance.

In an alternative embodiment, the lower end woofers, one or more can be mounted to the center sound board.

In an alternative embodiment, one or more midrange speakers could be mounted to the central sounding board or mounted above the sounding board.

In another alternative embodiment, the higher end tweeter or tweeters would work best if mounted above the lower end speakers closer to the exit sounding hole.

The circular shaped enclosure can also be mounted inside an electrically amplified musical instrument such as a guitar, piano, or PA system or hand held device.

The circular shaped enclosure can be construction from a variety of materials such as wood, plastic, or metals. Provided that such material will trap air to create the oscillating effects.

This speaker enclosure in the preferred embodiment of the invention is designed to be used wherein the opening is pointed upward to allow the music to resonate in a 360 degree radius. However, if desired the enclosure could be titled forward at any angle to allow the sound to be projected in a forward direction.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, paragraph 6. In particular, the use of “step of” in the claims herein is not intended to invoke the provisions of 35 U.S.C. §112, paragraph 6.

While the description above refers to particular embodiments of the present invention, it will be understood that many modifications may be made without departing from the spirit thereof. The presently disclosed embodiments are therefore to be considered in all respects as illustrative and not restrictive

What is claimed is:

1. A device comprising:
a circular shaped resonating chamber having an upper resonating chamber and a lower resonating chamber, which are joined together by a sound board;
said sound board divides said upper resonating chamber and said lower resonating chamber;
one or more speakers are mounted to said sound board;
said sound board has one or more breather holes;
said upper resonating chamber has one or more exit holes for the sound to escape; and
a base member for holding said circular shaped resonating chamber.

2. A device as defined in claim 1, wherein an electrical signal is sent to said speaker causing it to expand and contrast raising and lowering the pressure in said upper resonating chamber and said lower resonating chamber, wherein said lower resonating chamber draws air in or out through said breather holes located in said sound board, said air pressure moves through said breather holes from said lower resonating chamber into said upper resonating chamber along an interior resonating chamber wall to exit through said sound hole of the upper resonating chamber, and wherein said circular shaped resonating chamber allows the sound waves from said speaker to resonate sound into said sound board and out through the circular shaped structured walls-outward in a 360 degree radius.

3. A device as defined in claim 1, wherein said circular shaped resonating chamber is construct from materials chosen from the group consisting of wood, plastic, or metals.

4. A device as defined in claim 1, wherein said base member is a guitar amplifier.

5. A device as defined in claim 1, wherein said base member has tilt screws to allow for the adjustment of said circular shaped resonating chamber.

6. A device as defined in claim 1, wherein when said exit hole is pointed vertically up, music will resonate in a 360 degree radius.

7. A speaker device comprising:
a resonating chamber having an upper resonating chamber and a lower resonating chamber, which are joined together by a sound board;
said sound board divides said upper resonating chamber and said lower resonating chamber;
one or more speakers are position around said sound board;
said sound board has one or more breather holes; and
said upper resonating chamber has one or more exit holes for the sound the sound to escape.

8. A speaker device as defined in claim 7, wherein said resonating chamber is construct from materials chosen from the group consisting of wood, plastic, or metals.

9. A speaker as defined in claim 7, wherein said resonating chamber has a oblong shape.

10. A speaker as defined in claim 7, wherein said resonating chamber has a circular shape.

11. A speaker as defined in claim 7, wherein said exit hole is pointed vertically up, music will resonate in a 360 degree radius.

12. A speaker as defined in claim 7, wherein an electrical signal is sent to said speaker causing it to expand and contrast raising and lowering the pressure in said upper resonating chamber and said lower resonating chamber, wherein said lower resonating chamber draws air in or out through said breather holes located in said sound board, said air pressure moves through said breather holes from said lower resonating chamber into said upper resonating chamber along an interior resonating chamber wall to exit through said sound hole of the upper resonating chamber, and wherein said circular shaped resonating chamber allows the sound waves from said speaker to resonate sound into said sound board and out through the circular shaped structured walls outward in a 360 degree radius.

13. A device comprising:
a resonating chamber having an upper resonating chamber and a lower resonating chamber, which are joined together by a sound board;
said sound board divides said upper resonating chamber and said lower resonating chamber;
one or more speakers are position around said sound board;
said sound board has one or more breather holes; and
said upper resonating chamber has one or more exit holes for the sound the sound to escape; and
a base member for holding said resonating chamber.

14. A device as defined in claim 13, wherein said resonating chamber is construct from materials chosen from the group consisting of wood, plastic, or metals.

15. A device as defined in claim 13, wherein said resonating chamber has a oblong shape.

16. A device as defined in claim 13, wherein said resonating chamber has a circular shape.

17. A device as defined in claim 13, wherein said exit hole is pointed vertically up the music will resonate in a 360 degree radius.

18. A device as defined in claim 13, wherein said base has tilt screws to allow for the adjustment of said resonating chamber.

19. A device as defined in claim 13, wherein said base member holding said resonating chamber is a guitar amplifier.

20. A device as defined in claim 13, wherein an electrical signal is sent to said speaker causing it to expand and contrast raising and lowering the pressure in said upper resonating chamber and said lower resonating chamber, wherein said lower resonating chamber draws air in or out through said breather holes located in said sound board, said air pressure moves through said breather holes from said lower resonating chamber into said upper resonating chamber along an interior resonating chamber wall to exit through said sound hole of the upper resonating chamber, and wherein said circular shaped resonating chamber allows the sound waves from said speaker to resonate sound into said sound board and out through the circular shaped structured walls outward in a 360 degree radius.
